(19) United States
(12) Patent Application Publication
(10) Pub. No.: US 2026/0286255 A1
(43) Pub. Date: Sep. 24, 2026

(54) SCENT BOOSTER FOR LAUNDRY

(71) Applicant: Tufco, L.P., Los Angeles, CA (US)

(72) Inventors: Egal Gabbay, Los Angeles, CA (US); Shahram Roozrokh, Hauppauge, NY (US)

(21) Appl. No.: 19/087,083

(22) Filed: Mar. 21, 2025

(51) Int. Cl. C11D 3/50; C11D 3/00; C11D 3/10; C11D 3/40

(52) U.S. Cl. CPC C11D 3/505; C11D 3/001; C11D 3/10; C11D 3/40

(57) ABSTRACT

A composition for use in scent booster beads comprises a first solubility agent, a second solubility agent, a fragrance and a fabric softening agent, all of these ingredients being present in varied amounts by weight of the composition. The composition may further comprise one or more stabilizers, deformation plasticity agents, textural agents, dyes and/or color agents.

### BACKGROUND

### Field

This disclosure relates to laundry scent booster compositions and methods for manufacturing laundry scent boosters.

### Description of the Related Art

Laundry soaps and detergents are a necessity of modern life, and there is a wide array of such products available to meet different consumer preferences and needs. The soaps and detergents may be configured to work best in certain types of washing machines, for example, and may comprise ingredients and concentrations thereof which take into account such factors as level of soiling, wash temperature, and the like.

One consideration for users of laundry soaps and detergents is whether the detergents are scented or unscented. This is a personal consumer choice, some preferring a non-scented laundry wash while others may prefer the inclusion in the detergent of a scent or fragrance. Amongst the latter group, the choices are considerable, and many detergents will incorporate a scent which has a certain fragrance or smell. The scents may be more subtle or more noticeable and may be configured so as to have a longer or shorter duration on clothing which has been washed using such a detergent. There are many options in the manufacture of such detergents.

Scent boosters are a related product category. Scent boosters allow the consumer to set a fragrance or smell to their preference, apart from that provided by the soap or detergent. Some soaps and detergents include a scent booster. Scent boosters typically are formed into small units, often in the size and shape of beads, which are solid at room temperature and dissolve in a washing machine to release fragrance.

Temperatures in a washing machine may vary, and typically may be selected by the user. Typical washing machines either allow the user to select a specific temperature (often available in increments such as ten degrees) or have relative temperature options usually designated as hot, warm, cool and cold. These settings correspond to a temperature of water which is introduced into the washing machine's wash tub. Hot is generally 54 C to 60 C. Warm is generally between 32 C to 49 C. Cold is generally between 15 C to 30 C.

Fabric softeners are another type of laundry product, designed with air dried clothes in mind. The moisturizing ingredients found in fabric softeners work to soften out the harshness that often comes from air drying clothes. However, typical fabric softeners can be used with various types of clothes and fabrics. They are also known for enhancing and adding scents alongside laundry detergent.

Fabric softeners usually work by covering fabrics with different mixtures of chemicals that are designed to be electrically charged. Because of this, they make the threads in the fabrics stand on end which gives them a thicker, usually softened, feel. The main ingredient in most fabric softeners is a surfactant derived from quaternary ammonium, and therefore fabric softeners can be irritating to skin and nasal tissue.

The main difference between scent boosters and fabric softeners is that scent boosters typically only add or enhance fragrance while fabric softeners may do the same but always soften clothes and other fabrics. A scent booster is typically a salt-based water-soluble product; a fabric softener is typically an oil-based conditioner. Scent boosters only add or enhance fragrances; they do not soften or fluff clothes, towels, and sheets the way fabric softeners do. The other significant difference between scent boosters and fabric softeners is that they are added to the wash cycle at different times. Scent boosters are there from the start as you must put them in the wash basin before you put your clothes in. However, fabric softener is usually released near the end of the wash cycle.

Although scent boosters and fabric softeners accomplish similar goals, they typically function very differently. Fabric softeners often last longer than scent boosters; however, they are not all that environmentally friendly or sustainable and do not work well with certain types of clothing and fabric. Scent boosters are considered to be safe for use with any and all types of fabrics and colors.

### DETAILED DESCRIPTION

Several scent boosters are described herein, as well as methods of manufacture. The scent boosters described herein are unlike typical scent boosters because they include fabric softener functionality.

The disclosure is for a composition for use as, or in the form of, a scent booster bead in a laundry wash, wherein the composition is comprised of a first solubility agent; a second solubility agent; fragrance; and a fabric softening agent. The composition may further comprise one or more stabilizers, deformation plasticity agents, textural agents, dyes and/or color agents. The disclosed formulations may be stand-alone or used in laundry detergents and soaps, in order to enhance the smell of freshly washed clothes and linens, and to function as a fabric softener.

The first solubility agent may be one or more of sodium acetate.3H2O, sodium acetate, sodium sulfate decahydrate or calcium chloride hexahydrate. The first solubility agent may be included to help dissolve the composition in water and also potentially increase viscosity. The first solubility agent may comprise 30% to 45% of the composition by weight, such as 35% to 40%, and may be 36%, 38%, 42%, 44% by weight.

The second solubility agent may be one or more of soda ash, sodium chloride, sodium bicarbonate, sodium citrate, sodium sulphate, and sodium phosphate. The second solubility agent may be present to achieve desired pH levels and to facilitate wax formation if a solid product is desired. The second solubility agent may comprise 30% to 45% of the composition by weight, such as 35% to 40%, and may be 37.5%, 38.0%, 41.5%, 42.5%, 43.5%, 44.5% of the composition by weight.

The fragrance may be present by 5% to 20% by weight. The fragrance may be freely dispersed in the composition and/or may be encapsulated or otherwise used to release in circumstances or environments on a time release basis. Encapsulated fragrance may be 3% to 10% by weight, and free/oil fragrance may be 2% to 10% by weight. In formulations, the fragrance may comprise 4%, 5%, 6%, 7% encapsulated and 3.0%, 3.3%, 3.4%, 3.6%, 3.8% free. The relative proportions may be varied.

The fabric softening agent may be a surfactant, an emulsifier, dimethicone and/or a sour agent. The fabric softening agent may comprise 3% to 10% of the composition by weight, such as 6% to 7%, and may be 4.5%, 5.5%, 6.5%, 8.5%, 9.5% by weight. The surfactant may be cationic, such as a quaternary ammonium compound such as disunfloweroylethyl dimonium chloride. The surfactant may be nonionic and also function as an emulsifier, such as lauryl lactyl lactate, laureth-7 or polyethylene oxide surfactants. The emulsifier may be sunflower lecithin, brassica glycerides, soy lecithin, rapeseed lecithin, coconut lecithin or sunflower seed oil glycerides. The dimethicone may be polydimethylsiloxane (PDMS), and alternatives include vegetable glycerin, sodium carbonate decahydrate or a vinegar and baking soda mixture.

The dye or color agent may take the form of color slurry. The dye or color agent allows the composition to be of the desired hue to enhance the appeal or appearance of the product. The color slurry may be achieved by adding color powder to some or all of the fragrance to form a mixture which then becomes a component of the composition. The dye or color agent may be present in the composition between 0.02% and 1.5% by weight, or 0.07%, 0.08%, 1%, 1.2%, 1.3% by weight.

A stabilizer may be included which provides humidity absorption. This humidity absorption stabilizer may be a choline salt such as choline bicarbonate or calcium chloride in an amount of 1% to 5% by weight, such as 1% to 2%, and may be 1%, 1.2%, 1.3%, 2% by weight. Other humidity absorbers such as silica gel may be used.

A stabilizer may be included which helps to retain the free fragrance in the scent booster. This free fragrance retention stabilizer may be stearyl alcohol, cetyl alcohol, a fixative such as hydroxyethyl urea cetyl nonanoate or polyvinyl pyrrolidone derivatives in an amount of 3% to 10% by weight, or 4%, 5%, 6%, 7% by weight. This stabilizer may also impact viscosity of the scent booster.

A deformation plasticity agent may be included as a hardness helper. The deformation plasticity agent may be starch ether, hydroxypropyl cellulose (HPC), hydroxypropyl methylcellulose (HPMC), hydroxyethyl cellulose (HEC), methyl cellulose (MC), sodium carboxymethyl cellulose (CMC-Na) in an amount of 0.5% to 5% by weight, or 0.75%, 1.5%, 2.5%, 3.5% by weight.

A textural agent may be included to reduce stickiness of the scent booster. The textural agent may be sodium polyacrylate, non-hygroscopic polyethylene glycol, maltodextrin, monoglycerides and vegetable oil in an amount of 1% to 5% by weight, or 1%, 1.25%, 2.5%, 3.5%, 4% by weight.

The scent booster may include a detergent so that the scent booster cleans the clothes, imparts a fragrance to the clothes and functions as a fabric softener.

The various ingredients may be selected and compounded such that free fragrance, encapsulated fragrance, fabric softener and (if included) detergent are released from the beads at different times.

The composition may be manufactured by several different procedures which will achieve the end result of a composition having the relative proportions of ingredients as described above. To formulate beads from the composition, the ingredients may be mixed together and then extruded, granulated, molded or formed into beads which are solid at room temperature. Depending on the ingredients, the formulation type, the desired shape and desired structure, it may be desirable to control temperature, pressure, humidity, available volume. These variables controls may be controlled to be raised, lowered and varied continuously or over time, to achieve the desired output.

In a first step, the first solubility agent is put into a reactor vessel and melted. Some first solubility agents will have a small quantity water in their structure. This water may be desirable for dissolving other ingredients, such as the humidity absorption stabilizer. It may be desirable to minimize the time that the first solubility agent is melted because it can lead to phase separation including evaporation of water from the first stability agent. Thus, when the first stability agent has melted, the humidity absorption stabilizer is added to the reactor vessel and mixed with the first solubility agent. The mixing time may be five to ten minutes.

Next, the second solubility agent is added to the reactor vessel and the contents mixed for up to fifteen minutes.

Next the encapsulated fragrance is added to the reactor vessel and the contents mixed for up to about five minutes. It may be desirable to perform this mixing vigorously.

Next the free fragrance is added and mixed for 15 minutes.

Next the free fragrance retention stabilizer is added and mixed for 20 minutes.

Next the fabric softening agent is added and mixed for 20 minutes.

Next the deformation plasticity agent is added and slowly mixed in.

Next the textural agent is added and mixed well.

The mixture may then be brought to room temperature (i.e., 13° C.-30° C.), for example by cooling.

As new ingredients are added, it may be desirable to increase or decrease the temperature so that the mixture has an appropriate quality at the time, such as solubility, flowability and pourability. The temperature range may be adjusted at each point as appropriate to obtain satisfactory results.

Once the ingredients of the composition have been added and mixed as set out above, or through a variation or alternative procedure, the product may be rendered into any one of many desired shapes and sizes. This may be effected by placing or dropping the product taken from the principal reactor on a cold surface and waiting for it to cool, whereupon it will be solidified and ready for further processing. In one example, the process is performed at sea level and the product is formed into beads.

The scent booster may be a solid at room temperature and dissolves from exposure to water. In bead form, the scent booster may therefore distribute is components evenly during a wash cycle.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A composition for use as a scent booster bead comprising:
a first solubility agent in an amount of 30% to 45% by weight of the composition;
a second solubility agent in an amount of 30% to 45% by weight of the composition;
fragrance in an amount of 5% to 20% by weight of the composition;
a humidity absorption agent in an amount of 1% to 5% by weight of the composition;
a fabric softening agent in an amount of 3% to 10% by weight of the composition;
a deformation plasticity agent in an amount of 0.5% to 5% by weight of the composition; and
a textural agent in an amount of 1% to 5% by weight of the composition.

2. The composition of claim 1 wherein the scent booster bead is a solid at room temperature and dissolves from exposure to water.

3. The composition of claim 1 further comprising a free fragrance retention stabilizer in an amount of 3% to 10% by weight of the composition.

4. The composition of claim 1 wherein the first solubility agent is at least one of sodium acetate.3H2O, sodium acetate, sodium sulfate decahydrate and calcium chloride hexahydrate.

5. The composition of claim 4 wherein the first solubility agent is present in an amount of 35% to 40% by weight of the composition.

6. The composition of claim 1 wherein the second solubility agent is at least one of soda ash, sodium chloride, sodium bicarbonate, sodium citrate, sodium sulphate, and sodium phosphorate.

7. The composition of claim 6 wherein the sodium bicarbonate is present in an amount of 35% to 40% by weight of the composition.

8. The composition of claim 1 wherein the fragrance comprises:
encapsulated fragrance in an amount of 3% to 10% by weight of the composition; and
free fragrance in an amount of 2% to 10% by weight of the composition.

9. The composition of claim 8 wherein the encapsulated fragrance is present in an amount of 5% to 7% by weight of the composition.

10. The composition of claim 8 wherein the free fragrance is present in an amount of 3% to 4% by weight of the composition.

11. The composition of claim 8 further comprising free fragrance retention stabilizer in an amount of 3% to 10% by weight of the composition.

12. The composition of claim 11 wherein the free fragrance retention stabilizer is present in an amount of 4% to 6% by weight of the composition.

13. The composition of claim 11 wherein the free fragrance stabilizer is at least one of stearyl alcohol, cetyl alcohol, a fixative such as hydroxyethyl urea cetyl nonanoate and polyvinyl pyrrolidone derivatives.

14. The composition of claim 1 further comprising a color slurry.

15. The composition of claim 13 wherein the color slurry is present in an amount of 0.02% to 1.5% by weight of the composition.

16. The composition of claim 1 wherein the humidity absorption agent is a choline salt and is at least one of choline bicarbonate and calcium chloride.

17. The composition of claim 1 wherein the fabric softening agent comprises at least one of a surfactant, an emulsifier, dimethicone and a sour agent.

18. The composition of claim 1 wherein the fabric softening agent comprises at least one of disunfloweroylethyl dimonium chloride, lauryl lactyl lactate, laureth-7, polyethylene oxide, sunflower lecithin, brassica glycerides, soy lecithin, rapeseed lecithin, coconut lecithin, sunflower seed oil glycerides, polydimethylsiloxane, vegetable glycerin, sodium carbonate decahydrate, or a vinegar and baking soda mixture.

19. The composition of claim 1 wherein the deformation plasticity agent comprises at least one of starch ether, hydroxypropyl cellulose, hydroxypropyl methylcellulose, hydroxyethyl cellulose, methyl cellulose, sodium carboxymethyl cellulose.

20. The composition of claim 1 wherein the textural agent comprises at least one of sodium polyacrylate, non-hygroscopic polyethylene glycol, maltodextrin, monoglycerides and vegetable oil.

21. A composition for use as a scent booster comprising:
a first solubility agent in an amount of 30% to 45% by weight of the composition and comprising at least one of sodium acetate.3H2O, sodium acetate, sodium sulfate decahydrate and calcium chloride hexahydrate;
a second solubility agent in an amount of 30% to 45% by weight of the composition and comprising at least one of soda ash, sodium chloride, sodium bicarbonate, sodium citrate, sodium sulphate, and sodium phosphorate;
fragrance in an amount of 5% to 20% by weight of the composition;
a humidity absorption agent in an amount of 1% to 5% by weight of the composition and is at least one of choline bicarbonate and calcium chloride;
a fabric softening agent in an amount of 3% to 10% by weight of the composition and is at least one of disunfloweroylethyl dimonium chloride, lauryl lactyl lactate, laureth-7, polyethylene oxide, sunflower lecithin, brassica glycerides, soy lecithin, rapeseed lecithin, coconut lecithin, sunflower seed oil glycerides, polydimethylsiloxane, vegetable glycerin, sodium carbonate decahydrate, or a vinegar and baking soda mixture;
a deformation plasticity agent in an amount of 1% to 5% by weight of the composition and is at least one of starch ether, hydroxypropyl cellulose, hydroxypropyl methylcellulose, hydroxyethyl cellulose, methyl cellulose, sodium carboxymethyl cellulose; and
textural agent in an amount of 1% to 5% by weight of the composition and is at least one of sodium polyacrylate, non-hygroscopic polyethylene glycol, maltodextrin, monoglycerides and vegetable oil.

22. A composition for use as a scent booster comprising:
a first solubility agent in an amount of 35% to 40% by weight of the composition;
a second solubility agent in an amount of 35% to 40% by weight of the composition;
encapsulated fragrance in an amount of 3% to 10% by weight of the composition;
free fragrance in an amount of 2% to 10% by weight of the composition;
a free fragrance retention stabilizer in an amount of 3% to 10% by weight of the composition;
a humidity absorption agent in an amount of 1% to 2% by weight of the composition;
a fabric softening agent in an amount of 6% to 7% by weight of the composition;
a deformation plasticity agent in an amount of 0.5% to 5% by weight of the composition; and
a textural agent in an amount of 1% to 5% by weight of the composition.
